(19) United States
(12) Patent Application Publication
(10) Pub. No.: US 2009/0194920 A1
(43) Pub. Date: Aug. 6, 2009

(54) Integrated Suspension Control Device

(75) Inventors: Mickey L. Love, Londonderry, NH (US); Robert S. Feldmann, Londonderry, NH (US); David A. Mauceri, Londonderry, NH (US); Robert J. Ramm, Amherst, NH (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 12/023,160

(22) Filed: Jan. 31, 2008

(51) Int. Cl. F16F 13/00; F16F 9/00

(52) U.S. Cl. 267/121; 267/140.11

(57) ABSTRACT

A suspension device is provided having a casing that defines a cavity, which further defines a stop face. A piston is slidably disposed in the cavity and offset from the stop face, wherein the piston is operable to move axially relative to the stop face when a force is imparted on at least one of the casing and the piston. A spring is disposed in the cavity and between the stop face and the piston, wherein the spring communicates with the piston and the end face and is operable to compress as the piston moves toward the end face and absorb the force. A friction damper is disposed in the cavity and operable to generate frictional drag between the piston and the casing, wherein the frictional drag inhibits axial movement of the piston in the cavity.

### FIELD

The present disclosure relates to a suspension system and, more particularly, a suspension system having a suspension control device that integrates various suspension system components into a single device.

### BACKGROUND

The statements in this section merely provide background information related to the present disclosure and may not constitute prior art.

Suspension systems are commonly disposed between two components to isolate one component from an impact that may be imparted on the other component. Generally, one of the components can move relative to the other component when subjected to the impact. Many suspension systems, such as a suspension system for a vehicle that connects the vehicle to its wheels, include a spring and a damper. The spring may compress to absorb the impact (i.e., jounce) and rebound back toward its normal position when the impact subsides (i.e., rebound). The spring may rebound, or extend, beyond its original position and oscillate between compression and extension until returning to its original position. The damper limits the motion of the spring to control this oscillation and helps the spring return more quickly to its original position.

Some suspension systems, and particularly vehicle suspension systems, often include other features, such as jounce bumpers, rebound bumpers, and isolators, which add complexity and cost to the suspension system. The jounce bumper and rebound bumper can generally be coupled to either component and limit the compression or extension of the spring during jounce and rebound. The isolators provide compliant mounting between the components to absorb low-amplitude, high-frequency vibrations.

It is desirable, therefore, to have a suspension system with reduced cost and complexity. It is further desirable to have a suspension component that incorporates some of the features described above into a single component.

### SUMMARY

In a first aspect of the present teachings, a suspension device is provided and includes a casing defining a cavity, which defines a stop face. A piston is slidably disposed in the cavity and offset from the stop face, wherein the piston is operable to move a predetermined axial distance toward the stop face when a force is imparted on one of the casing and the piston. A bumper member is disposed in the cavity and between the stop face and the piston, wherein the bumper member communicates with at least one of the piston and the end face and operates to elastically resist movement of the piston toward the end face when the piston reaches the predetermined distance.

In another aspect, a suspension device is provided and includes a casing defining a cavity, which defines a stop face. A piston is slidably disposed in the cavity and offset from the stop face, wherein the piston is operable to move a predetermined axial distance toward the stop face when a force is imparted on at least one of the casing and the piston. A spring is disposed in the cavity and between the stop face and the piston. The spring communicates with the piston and the end face and is characterized by a spring rate. The spring is operable to compress as the force is imparted on at least one of the casing and the piston, wherein compressing the spring absorbs the force and permits the piston to move the predetermined axial distance and the spring rate increases when the piston reaches the predetermined distance.

In yet another aspect, a suspension device is provided and includes a casing that defines a cavity, which further defines a stop face. A piston is slidably disposed in the cavity and offset from the stop face, wherein the piston is operable to move axially relative to the stop face when a force is imparted on at least one of the casing and the piston. A spring is disposed in the cavity and between the stop face and the piston, wherein the spring communicates with the piston and the end face and is operable to compress as the piston moves toward the end face and absorb the force. A friction damper is disposed in the cavity and operable to generate frictional drag between the piston and the casing, wherein the frictional drag inhibits axial movement of the piston in the cavity.

In yet another aspect, a damper is provided and includes a casing defining a cavity, which defines a stop face. A piston is slidably disposed in the cavity and defines an outer diameter, wherein the piston is operable to move axially relative to the stop face when a force impinges on at least one of the casing and the piston. An elastic body is disposed in the cavity and compressed between the outer diameter of the piston and the casing. The compressed elastic body is operable for damping axial movement of the piston in the cavity, wherein a magnitude of the damping changes as the piston moves axially in the cavity.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of an exemplary vehicle having a suspension system in accordance with the teachings of the present disclosure;

FIG. 2 is a perspective view of another exemplary vehicle having a suspension system in accordance with the teachings of the present disclosure;

FIG. 3 is a cross-sectional view of a suspension control device in accordance with the teachings of the present disclosure;

FIG. 4A is an exemplary spring force versus compression plot of the suspension control device of FIG. 3;

FIG. 4B is an exemplary spring rate versus compression plot of the suspension control device of FIG. 3;

FIG. 5 is a partial cross-sectional view illustrating a damping portion of the suspension control device of FIG. 3;

FIG. 6 is a partial cross-sectional view illustrating an alternative damping portion of the suspension control device of FIG. 3;

FIG. 7 is a partial cross-sectional view illustrating yet another alternative damping portion of the suspension control device of FIG. 3

FIG. 8 is a cross-sectional view of still another suspension control device in accordance with the teachings of the present disclosure; and

FIG. 9 is a cross-sectional view of still another suspension control device in accordance with the teachings of the present disclosure.

### DETAILED DESCRIPTION

The following description is merely exemplary in nature and is not intended to limit the present disclosure, application, or uses. Reference numerals are used herein to point out or describe particular components, features, or aspects of the present invention. The same reference numeral is used between the various embodiments when describing components, features, or aspects of the various embodiments that are the same. Reference numerals incremented by 1000 are generally used between the various embodiments when describing components, features, or aspects of the various embodiments that are similar to previously described components, features, or aspects of a previous embodiment(s). For example, the first suspension control device embodiment may be referred to as 22, and subsequent embodiments may be referred to as 1022, 2022, etc.

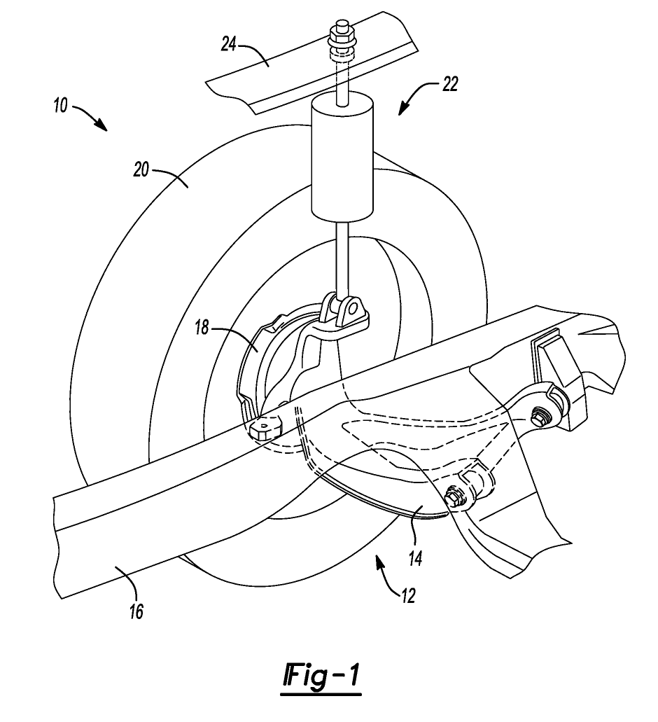

With reference to FIG. 1, a vehicle 10 is provided having a known suspension system 12, such as a McPherson type suspension system, which may include a wishbone control arm 14 coupled at one end to a frame 16 and at another end to a hub 18 of a wheel 20. The control arm 14 laterally locates the hub 18 and permits the hub 18 to move vertically relative to the frame 16. A suspension control device 22, as will be discussed later in greater detail, is fixed between the hub 18 and a body 24 of the vehicle 10. Configured in this manner, the control arm 14 and the suspension control device 22 maintain the hub 18 and the wheel 20 in a generally upright orientation. The suspension control device 22 can contract when a force acts on the wheel 20 to permit upward movement of the wheel 20, absorb the force such that only a portion of the force is transferred to the frame 16 and the body 24, and return to its original orientation.

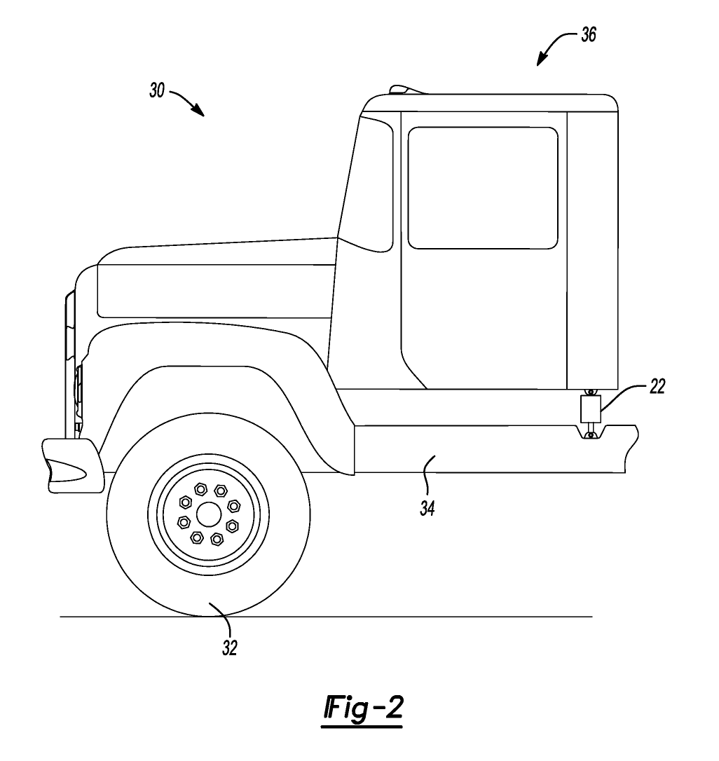

With reference to FIG. 2, a vehicle 30 is shown having wheels 32 coupled to a frame 34 and a passenger compartment 36 supported on the frame 34. At least one suspension control device 22 may be coupled between the frame 34 and the passenger compartment 36. The suspension control device 22 can contract when a force acts on the frame 34 through the wheels 32, absorb the force such that only a portion of the force is transferred to the passenger compartment 36, and return to its original orientation when the force subsides.

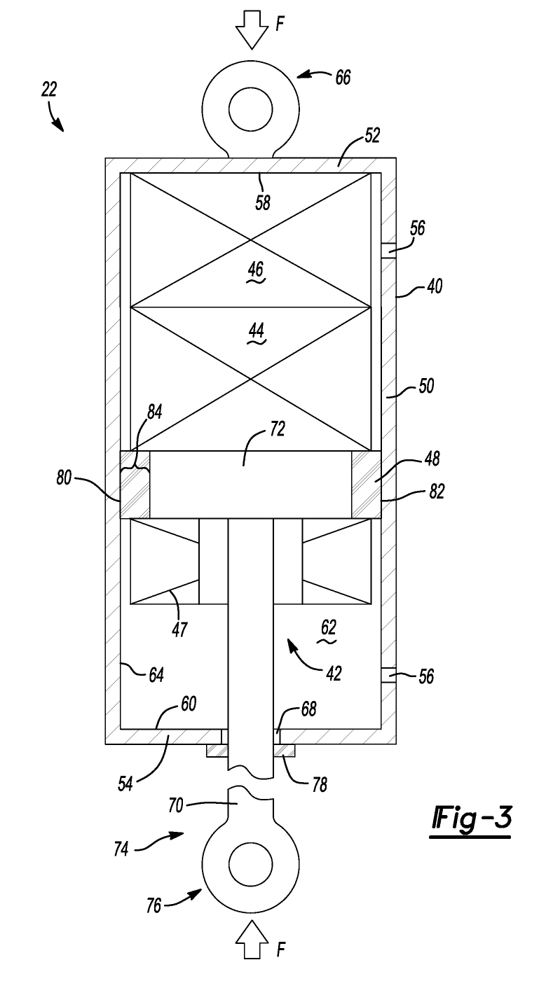

With reference to FIG. 3, a first embodiment of the suspension control device is shown and represented by the reference numeral 22. While the suspension control device and operation of the suspension control device are hereinafter described in this embodiment and in subsequent embodiments in relation to the vehicle 10, it will be appreciated that the suspension control device may be utilized in other vehicle and non-vehicle systems.

The suspension control device 22 may include an outer casing 40 that houses a piston assembly 42, a spring 44, a jounce bumper 46, a rebound bumper 47, and a damper 48, which may cooperate to control low-frequency and high-amplitude vibration of the vehicle 10. An isolating member (shown and described in subsequent embodiments) may be included to control high-frequency and low-amplitude vibrations of the vehicle 10. The outer casing 40 may receive the piston assembly 42 for slidable engagement therewith. The piston assembly 42 may support the spring 44 and the jounce bumper 46 between the piston assembly 42 and the casing 40. The spring 44 may communicate with the piston assembly 42 and support the jounce bumper 46. Alternatively, the jounce bumper 46 may communicate with the piston assembly 42 and support the spring 44. Further, the jounce bumper 46 and the spring 44 may be received within one another so that they act independently rather than in a stacked arrangement. The rebound bumper 47 may be disposed below the piston assembly 42 and between the piston assembly 42 and the casing 40. The damper 48 may be compressed between the casing 40 and the piston assembly 42.

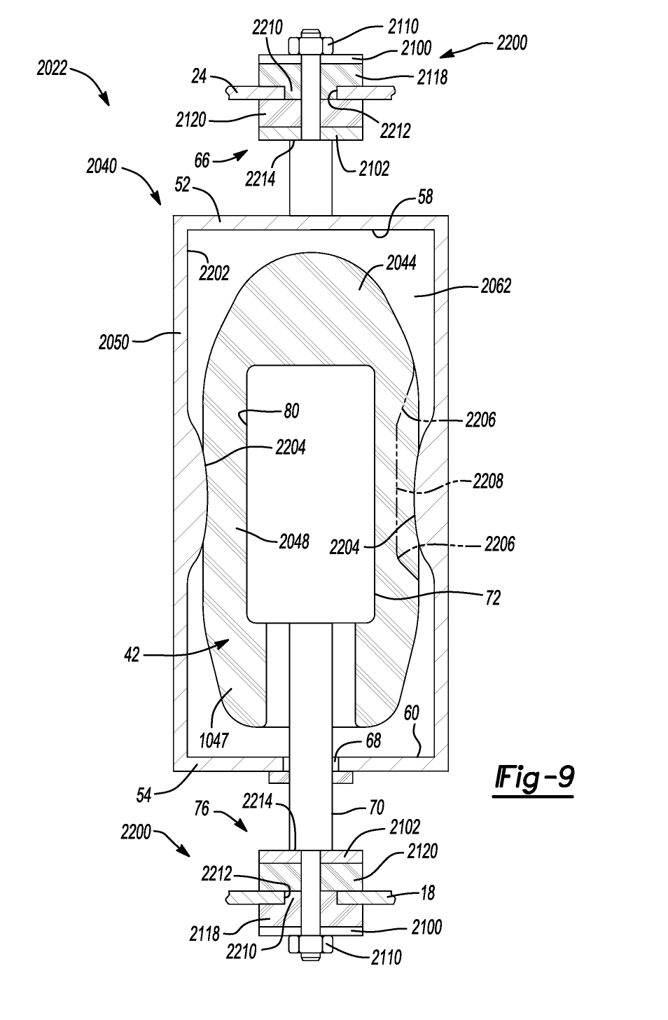

The outer casing 40 may include an elongate tubular body 50 and a pair of caps 52, 54 coupled to respective ends of the body 50 to define respective stop faces 58, 60 and a cylindrical cavity 62, which further defines an inner cylindrical face 64. The body 50 and the caps 52, 54 are preferably formed from a generally rigid material, such as steel or aluminum. Optional apertures 56 extending through the body 50 may be included to permit free or controlled air exchange into the cavity 62 for reasons which will be discussed later in greater detail. The cap 52 may be integrally formed with the body 50 utilizing a suitable method, such as deep drawing, or may be formed as a separate component. The cap 54 and, when appropriate, the cap 52 may be coupled to the body 50 utilizing a suitable method, such as by welding, threaded engagement, or other connecting methods. A connecting end 66, such as an eyelet or a bayonet mount (See FIG. 9), may be coupled to an exterior of the cap 52 to provide a mounting means for coupling the suspension control device 22 to the vehicle 10. An aperture 68 extending through the cap 54 may be configured to receive a connecting rod 70 of the piston assembly 42 in a manner that captures a piston body portion 72 of the piston assembly 42 within the cavity 62 when the cap 54 is coupled to the body 50.

The piston assembly 42 may transfer a force F acting on the piston assembly 42 to the spring 44 and the jounce bumper 46, and may include the connecting rod 70 coupled at one end to the piston body portion 72. The connecting rod 70 is preferably formed from a rigid material, such as steel or aluminum, and may include a connecting portion 74 coupled at the end opposite the piston body portion 72. The connecting rod 70 may be configured to be received by the aperture 68 and partially extend from the outer casing 40. The connecting rod 70 may be slidable within the aperture 68 such that the piston body portion 72 may slide within the cavity 62 as the connecting rod 70 slides in the aperture 68. The connecting portion 74 may include a connecting end 76, such as an eyelet or a bayonet mount, to provide a mounting means for coupling the suspension control device 22 to the vehicle 10. The connection ends 66, 76 may receive a force F and transfer the force F to the piston assembly 42 and the casing 40, respectively. An optional wiper seal 78 may be disposed around the connecting rod 70 and communicate with the cap 54 to inhibit contaminants, such as dirt and water, from entering the cavity 62 through the aperture 68 during operation of the suspension control device 22.

The piston body portion 72 may be formed from a rigid material, such as steel or aluminum, and may be generally cylindrically shaped. The piston body portion 72 may be secured to the connecting rod 70 in a manner suitable for providing driving engagement therebetween, such as by welding or mechanical fastening, when the force F acts on the piston assembly 42 or the casing 40. The piston body portion 72 may move axially relative to the end face 62 of the casing 40 when the force F acts on either one of the connecting ends 66, 76.

The spring 44 and the jounce bumper 46 may cooperate to absorb high-amplitude and low-frequency forces, or vibrations, acting on the suspension control device 22 through the connecting ends 66, 76 and transferred by the piston assembly 42. The spring 44 may be a mechanical spring that may sufficiently compress to absorb at least a portion of the force F, such as a conventional coil spring or an elastomeric spring. The spring 44 may be characterized by a constant or variable spring rate. In some instances, and particularly when the spring 44 is a conventional coil spring, the spring 44 may compress to a block height, or bind, wherein a maximum compression of the spring 44 has been realized.

The jounce bumper 46 may generally prevent the suspension control device 22 from bottoming out (i.e., reaching a maximum compressed height associated with the bound spring 44) when the spring 44 absorbs the force F by providing additional shock absorption. The jounce bumper 46 may be formed from an elastomeric material that is suitable for shock absorption and characterized by a progressive spring rate. The progressive spring rate generally continually increases with continued compression of the jounce bumper. Accordingly, the jounce bumper 46 does not bind with continued compression, but provides a continually increasing biasing force to resist and absorb the force F. The progressive spring rate (force/deflection curve increases) generally prevents the suspension control device 22 from bottoming out and transferring the force F from the wheel 20 to the body 24 of the vehicle 10 instead of absorbing the force F. Microcellular polyurethane (MCU) has been found to exhibit the desirable progressive spring rate characteristic for the jounce bumper 46.

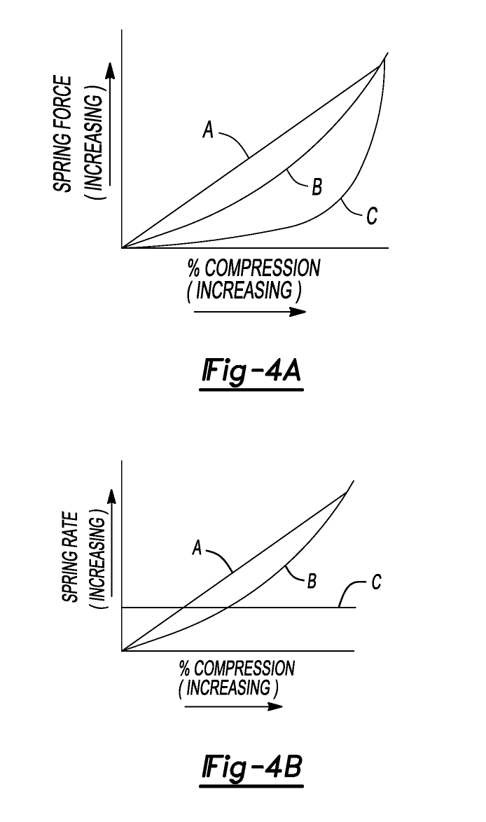

Examples of progressive spring force/deflections are illustrated by curves A, B, and C of FIG. 4A. Curves A and B show an increasing spring force as the percent compression of the jounce bumper 46 increases. The curve A shows a generally linear progressive spring force. The curve B shows a non-linear progressive spring force exhibiting a generally hyperbolic spring force increase as percent compression increases. Curve C exhibits another hyperbolic spring force increase as percent compression increases, and is generally representative of a spring force versus compression curve achieved by use of MCU, which exhibits a generally constant spring rate during initial compression. It will be appreciated that the curves A, B, and C are exemplary only and do not reflect actual spring force versus percent compression data.

FIG. 4B illustrates exemplary spring rate versus compression curves. Curve A represents a linear curve, Curve B represents non-linear spring rate versus compression curve, and Curve C represents a constant spring rate versus compression curve.

A configuration of the jounce bumper 46 may influence the spring rate so that the spring rate is similar to the spring rate illustrated by one of the curves A, B, and C. For example, the jounce bumper 46 having a generally constant cross-section may exhibit a progressive spring rate similar to curve A. Changing a height or cross-section, or selecting a material having different mechanical properties, may advantageously change the spring rate such that the slope of curve A increases or decreases. For another example, providing the jounce bumper 46 with a varying cross-section, such as a conical shape, may cause the spring rate to be similar to the non-linear, spring rate illustrated by curve B. The trajectory of the non-linear spring rate curve B may be changed by further altering a height of the spring, varying the cross-sectional geometry of the spring, or selecting a material having different mechanical properties.

One can envision a wide variety of spring 44 and jounce bumper 46 combinations that may incorporate spring rates as described above to advantageously control compression of the spring 44 and the jounce bumper 46 when the force F acts on the suspension control device 22 to optimize performance of the suspension control device 22. For example, the spring 44 may have a linear spring rate and provide less stiffness than the jounce bumper 46. This may create a spring rate that is initially generally linear as the spring 44 compresses but non-linear when the spring 44 approaches maximum compression. Such a spring rate may be particularly well-suited for vehicle applications, as it may provide a smoother vehicle ride over a longer jounce stroke of the suspension control device 22, yet accommodate larger impact forces that may frequently occur, such as when the vehicle 10 experiences a large impact force (e.g., runs over a pothole).

The rebound bumper 47 may bias the piston body portion 72 away from the stop face 60 when the rebound bumper 47 is compressed between the stop face 60 and the head portion during a rebound stroke. The rebound bumper 47 may be a mechanical spring, such as a conventional coil spring or an elastomeric body. A spring rate of the rebound bumper 47 is not of great importance, provided a magnitude of a biasing force of the compressed rebound bumper 47 is sufficient to overcome any damping, which will be discussed later in greater detail, and return the piston body portion 72 to its original position associated with the curb height of the suspension control device 22.

The damper 48 may be disposed between the piston assembly 42 and the casing 40 to control, or dampen, oscillation of the suspension control device 22 by resisting axial movement of the piston body portion 72 in the cavity 62. The damper 48 may be fixed to the piston body portion 72 and may define an outer diameter 80 (i.e., uncompressed diameter) that is larger than a diameter of the inner cylindrical face 64 such that the damper 48 is compressed between the piston body portion 72 and the casing 40. The compressed portion of the damper 48 may define a contact area 82. The compressive force distributed over the contact area 82 may generate frictional drag between the damper 48 and the casing 40 that may resist, or dampen, axial movement of the piston body portion 72 within the cavity 62. Damping may reduce or eliminate oscillation of the suspension control device 22, depending on a magnitude of the damping. It will be appreciated that the damper 48 may be coupled to either the piston body portion 72 or the casing 40. Accordingly, it will be further appreciated that communication between the damper 48 and the casing 40 or communication between the damper 48 and the piston body portion 72 may define the contact area 82.

The magnitude of the damping may be increased or decreased by changing the compressive force or a size of the contact area 82. It will be appreciated that the damping effect may be increased or decreased by simultaneously changing both the contact area 82 and the compressive force. Increasing or decreasing a thickness (i.e., uncompressed thickness) of the damper 48 relative to a gap 84 between the piston body portion 72 and the inner face 64 may correspondingly increase or decrease the magnitude of the compressive force and, therefore, the damping. For example, simply increasing the diameter of the damper 48 may increase the compressive force. For another example, reducing the gap 84 between the piston body portion 72 and the inner face 64 may increase the compressive force.

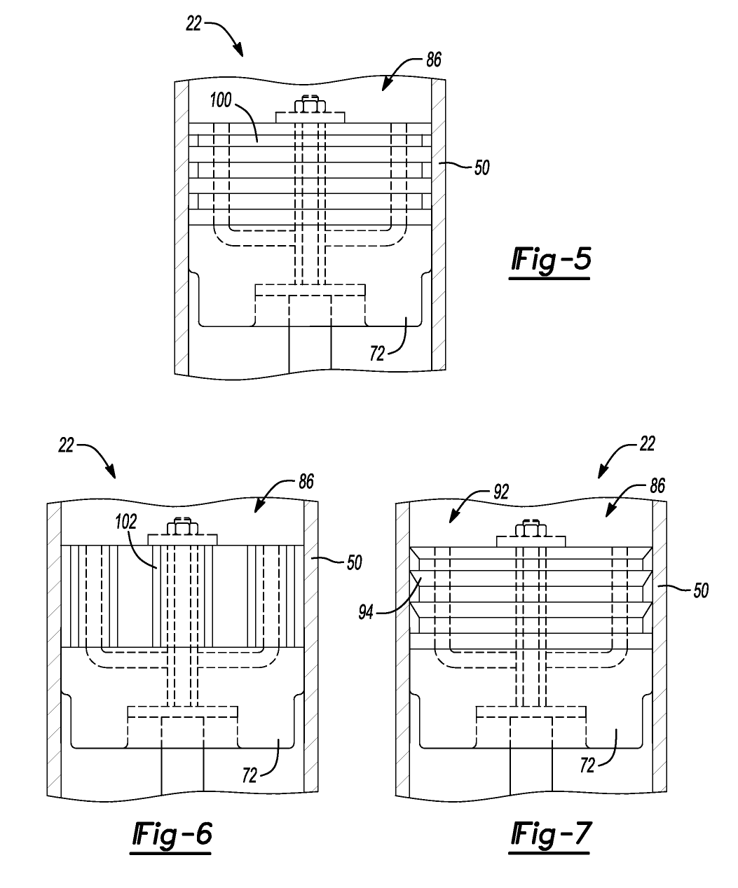

With particular reference now to FIGS. 5-7, the damper 48 may include a tuning feature 86 cut, coined, extruded, or otherwise formed into or onto the contact area 82 that may change the size of the contact area 82 or the compressive force to optimally adjust the damping. For example, horizontal or vertical grooves 100, 102, respectively, formed in the contact area 82 may advantageously reduce the contact area 82 (FIGS. 5 and 6). In addition, the grooves 100, 102 may permit deformed material to impinge in the grooves 100, 102, thereby reducing the compressive force. In some instances, the vertical grooves 102 may provide added benefit by allowing air to be exchanged between the areas above and below the piston body portion 72. For another example, a protruding body 92 having triangularly-shaped teeth 94, in cross-section, may define the contact area 82 (FIG. 7). The teeth 94 may be symmetrical such that the compressive force is the same regardless of an axial direction of travel of the damper 48. Alternatively, the teeth 94 may be non-symmetrical (i.e., have off-center peaks or features) such that the compressive force of the damper 48 moving in one axial direction is different than the compressive force in the opposite axial direction. Accordingly, the magnitude of the damping effect in a downward stroke of the piston assembly 42 may be different than in an upward stroke of the piston assembly 42.

The suspension control device 22 may incorporate other damping methods in addition to the frictional damping disclosed, such as compressed air damping. For example, the apertures 56 may be eliminated or configured to control the flow of air into or out of the cavity 62 when the piston body portion 72 moves axially within the cavity 62, which may compress air in the cavity 62 and further resist axial movement of the piston body portion 72. For another example, controlling the flow of air within the cavity 62 may create compressed air damping. In this regard, the vertical grooves 102 may be particularly effective to control the air flow between upper and lower portions of the cavity 62 that are separated by the piston body portion 72.

Operation of the suspension control device 22 will now be described in greater detail. The axial force F acting on either or both of the connection ends 66, 76 may compress the suspension control device 22 such that an axial distance between the stop face 58 of the casing 40 and the piston body portion 72 of the piston assembly 42 is reduced. Continued movement of the piston assembly 42 may compress and energize the spring 44 and, to some degree, the jounce bumper 46. The energized spring 44 may bias the casing 40 and the piston assembly 42 axially apart. When the force F is imparted by a predetermined static weight or load of the vehicle, the bias from the spring 44 (or combined bias of multiple springs 44 if the vehicle 10 includes multiple suspension control devices 22) will equalize with the weight of the vehicle 10 and maintain the suspension control device 22 at a compressed length (i.e., curb height).

Increasing the force F may further compress the suspension control device 22 beyond the curb height such that the distance between the stop face 58 and the piston body portion 72 is further reduced (i.e., jounce). The increased force F may be due to additional weight added to the vehicle or an impact force experienced by the vehicle 10 when the vehicle is driven on an uneven or rough road surface. The additional compression may further energize the spring 44 and increase the bias of the spring 44 on the outer casing 40 and the piston assembly 42 to accommodate, or absorb, the increased force. The spring 44 may equalize with the increased force F and maintain the suspension control device 22 at a new compressed length until the increased force F subsides or is removed. As is commonly understood in systems utilizing spring members, the spring 44 may oscillate, or alternate between expansion and compression, before settling to the new compressed length. It should be noted and appreciated that the jounce bumper 46 may also experience some compression and absorb a portion of the force F.

The spring 44 may bind when a magnitude of the force F is sufficiently large. If the spring 44 binds, the jounce bumper 46 may further compress and absorb that portion of the force F which has not already been absorbed by the spring 44. The jounce bumper 46, however, generally will not bind, thereby preventing the suspension control device 22 and, ultimately, the vehicle 10 from bottoming out.

Energy stored in the compressed spring 44 (and the jounce bumper 46) may urge the outer casing 40 and the piston assembly 42 axially apart when the increased force F subsides or is removed (i.e., rebound), thereby increasing the axial distance between the stop face 58 of the casing 40 and the piston body portion 72. The amount of absorbed energy released by the spring 44 and the jounce bumper 46 may cause the suspension control device 22 to expand beyond the curb height, which may compress and energize the rebound bumper 47. The energized rebound bumper 47 may urge the outer casing 40 and the piston assembly 42 axially apart, thereby urging the suspension control device 22 back toward the curb height. It will again be understood that the suspension control device 22 may oscillate before settling back to the curb height.

The damper 48 may dampen movement of the piston assembly 42 as the force F increases and subsides to oscillate the suspension control device 22 between jounce and rebound. The damper 48 can be configured in a desirable manner to control the damping action. For example, the teeth 94 can be adapted to increase the magnitude of the damping during the jounce stroke to help absorb the force. The teeth 94 can be further adapted to decrease the magnitude of the damping during the rebound stroke to permit the suspension control to quickly return to the curb position yet limit oscillation of the suspension control device 22 between the rebound and jounce conditions. Compressed air damping provided by relative movement between the piston body portion 72 of the piston assembly 42 and the casing can be utilized to further desirably control the damping action.

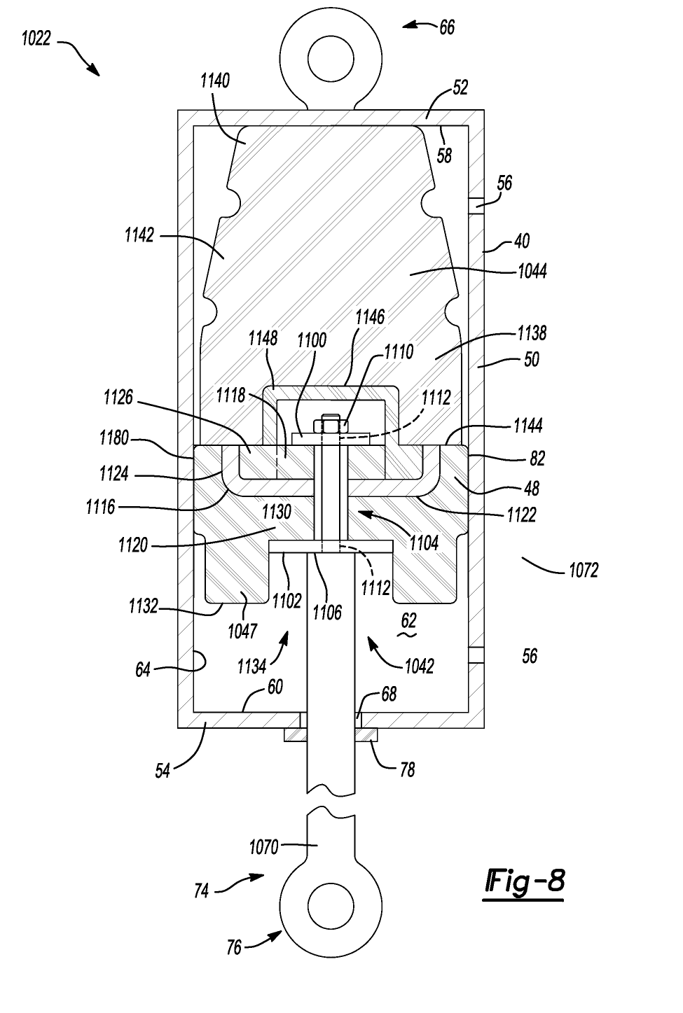

With reference now to FIG. 8, another embodiment of a suspension control device is shown and represented by the reference number 1022. The suspension control device 1022 may include the outer casing 40 that houses a piston assembly 1042, a jounce spring 1044, a rebound bumper 1047, and the damper 48. The piston assembly 1042 may support the jounce spring 1044 within the cavity 62.

The piston assembly 1042 may include a connecting rod 1070, an upper retainer 1100 and a lower retainer 1102 supported on the connecting rod 1070, and a piston body portion 1072 sandwiched between the upper and lower retainers 1100, 1102 to retain the piston body portion 1072 on the connecting rod 1070.

The connecting rod 1070 may include a driving portion 1104 at one end and the connecting portion 74 at the opposite end. The connecting rod 1070 may be configured to be received by the aperture 68 so that the connecting rod 1070 may partially extend from the outer casing 40. The wiper seal 78 may be disposed around the connecting rod 1070 and communicate with the cap 54 to inhibit contaminants, such as dirt and water, from entering the cavity 62 through the aperture 68 during operation of the suspension control device 22. The driving portion 1104 may define a shoulder 1106 and have a mechanical thread 1108 formed thereon, which may cooperate with a nut 1110 for securing the upper retainer 1100, the lower retainer 1102, and the piston body portion 1072 to the driving portion 1104. It will be appreciated, however, that any suitable coupling method could be used in place of mechanical threading for securing the upper and lower retainers 1100, 1102 and the piston body portion 1072 to the driving portion 1104.

The upper and lower retainers 1100, 1102 are preferably formed from a rigid material, such as steel or aluminum, and may be generally flat. Apertures 1112 extending through the retainers 1100, 1102 may receive the driving portion 1104 of the connecting rod 1070. The lower retainer 1102 may abut the shoulder 1106 to limit axial movement of the lower retainer 1102 along the connecting rod 1070 and provide driving engagement therebetween when the connecting rod 1070 moves in an upward direction. Similarly, the nut 1110 may abut the upper retainer 1100 and provide driving engagement therebetween when the connecting rod 1070 moves in a downward direction.

The piston body portion 1072 may include a cup 1116, which is sandwiched between an upper isolator 1118 and a lower isolator 1120, the rebound bumper 1047, and the damper 48. The cup 1116 may be formed from a rigid material, such as steel or aluminum, and may have a circularly shaped body 1122. A flange 1124 extending generally perpendicularly from and around the circular perimeter of the body 1122 may form a recess 1126 and define an outer diameter 1180. An aperture 1128 extending through the body 1122 may receive the driving portion 1104 of the connecting rod 1070 and be configured to have a radial clearance therebetween.

The upper and lower isolators 1118, 1120, the rebound bumper 1047, and the damper 48 may be integrally formed from an elastomeric material, such as MCU, and integrally coupled to the cup 1116 in a suitable manner, such as by over-molding. However, it will be appreciated that any one of or all of the upper and lower isolators 1118, 1120, the rebound bumper 1047, and the damper 48 may be formed as separate components and from different materials.

The upper and lower isolators 1118, 1120 may include apertures 1130 extending through the isolators 1118, 1120 and configured to receive and fit snugly around the driving portion 1104. The upper isolator 1118 may be configured to fit within the recess 1126 and may be sandwiched between the upper retainer 1100 and the body 1122 of the cup 1116. The lower isolator 1120 may be sandwiched between the lower retainer 1102 and the body 1122.

The rebound bumper 1047 may extend from the lower isolator 1120 toward the stop face 60. The rebound bumper 1047 may be annularly shaped and may define an end 1132 and a recess 1134. The end 1132 may communicate with the stop face 60 of the casing 40 when the suspension control device 1022 is compressed. The recess 1134 may provide radial clearance for the connecting rod 1070 and may receive the lower retainer 1102 to prevent communication between the lower retainer 1102 and the stop face 60 when the piston body portion 1072 moves axially toward the stop face 60.

The damper 48 may be disposed between the flange 1124 of the cup 1116 and the inner face 64 of the cavity 62 such that the damper 48 is compressed between the flange 1124 and the inner face 64 of the cavity 62. The damper 48 may include the previously-described tuning features 86.

The jounce spring 1044 may be disposed within the cavity 62 between the upper isolator 1118 and the stop face 58. The jounce spring 1044 may combine the functions of a traditional coil spring and jounce bumper combination utilized in many conventional suspension systems and, similarly, may combine the functions of the spring 44 and the jounce bumper 46. The jounce spring 1044 may be formed from an elastomeric material that has favorable properties for performing both of the spring 44 and the jounce bumper 46 function. For example, it is desirable that the jounce spring 1044 has a favorable compression to lateral expansion ratio suitable for shock-absorbing. It is further desirable that the jounce spring 1044 have a progressive spring rate suitable for preventing binding of the spring 1044. In this particular embodiment, the jounce spring 1044 may be formed from a medium or high-density MCU, which has been found to exhibit these desirable features. In addition, MCU is characterized by a spring rate that is speed sensitive due to a dynamic stiffness of the material, which may be utilized to further enhance performance of the suspension control device 1022.

The jounce spring 1044 may include cylindrical portions 1138, 1140, 1142 having different diameters and arranged in a stacked relationship that may provide a non-linear spring rate similar to the spring rate of curve B (FIG. 4). The portions 1138, 1140, 1142 may be integrally formed, such as by a rubber molding process or machining, but it will be appreciated that each portion 1138, 1140, 1142 could be separately formed and coupled in a suitable manner, such as by adhesion, or simply stacked on top of each other. The lower portion 1138 may define an end face 1144 that may communicate with the piston body portion 1072. A recess 1146 extending inward from the end face 1144 may provide clearance for the nut 1110 and the upper retainer 1102. The recess 1146 may also be configured to receive or be integrally coupled with a generally rigid isolator cup 1148, which may generally isolate the jounce spring 1044 from the upper isolator 1118 by communicating with and transferring the biasing force of the jounce spring 1044 to the piston body portion 1072 through the cup 1116 and not through the upper isolator 1118. The upper portion 1140 may include an end face 1150 that may communicate with the stop face 58. The middle portion 1142 may be disposed between the upper portion 1138 and the lower portion 1140. A relative diameter and a length of each portion 1138, 1140, 1142 increases progressively from the lower portion 1140 to the upper portion 1138.

With reference now to FIG. 9, another embodiment of a suspension control device is shown and represented by the reference number 2022. The suspension control device 2022 may include an outer casing 2040, the piston assembly 42, a jounce spring 2044, the rebound bumper 1047, and a damper 2048. The suspension control device 2022 may also include an externally mounted isolating member 2200.

The casing 2040 may include an elongate tubular body 2050 and the end caps 52, 54 coupled to respective ends of the body 2050 to define the respective stop faces 58, 60 and a cylindrical cavity 2062, which further defines the inner face 2202. A transition portion 2204 may extend from the inner face 2202 and into the cavity 2062 to give the inner face 2202 a generally hourglass shape. The aperture 68 and the cavity 2062 may slidably receive the connecting rod 70 and the piston body portion 72, respectively.

The jounce spring 2044, the rebound bumper 1047, and the damper 2048 may be integrally formed from an elastomeric material and integrally coupled to the piston body portion 72 of the piston assembly 42. It will be appreciated, however, that the jounce spring 2044, the rebound bumper 1047, and the damper 2048 may be formed as separate components or as a combination of separate components and integral components. It will further be appreciated that the jounce spring 2044, the rebound bumper 2047, and the damper 2048 may be formed from different materials, depending on the requirements of a particular suspension system. It should be noted, however, that at least the jounce spring 2044 should be made from MCU or another elastomeric material having the desirable properties previously discussed to fully realize the advantages of the present disclosure.

The jounce spring 2044 may be generally conically shaped having a domed upper portion that may communicate with the stop face 58. The tapered cross-section of the jounce spring 2044 may create a progressive spring rate similar to the spring rate shown in curve B (FIG. 3).

The damper 2048 may be compressed between the outer diameter 80 of the piston body portion 72 of the piston assembly 42 and the transition portion 2204 of the cavity 2062. Additional features, represented as phantom lines in FIG. 9, may be formed in a perimeter of the damper 2048 and may communicate with the transition portion 2204 as the piston body portion 72 moves axially within the cavity 2062. These additional features may advantageously provide a varying damping profile as the suspension control device 2022 experiences jounce and rebound. For example, any of the tuning features 86 previously described and illustrated in FIGS. 5-7 may be incorporated into the damper 2048 and operate as previously discussed. For another example, a tapered portion 2206 may increase or decrease the damping depending on the axial direction in which the piston body portion 72 moves and the slope direction of the tapered portion 2206. The tapered portion 2206 could be linearly or non-linear tapered to linearly or non-linearly change the damping. For yet another example, a clearance portion 2208 may provide clearance such that the transition portion 2204 does not communicate with or compress the damper 2048 when vertically aligned with the clearance portion 2208. Accordingly, no damping will occur when the transition portion is vertically aligned with the recess portion 2204.

The isolating member 2200 may be coupled between respective connecting ends 66, 76 and portions of the vehicle 10, such as the wheel hub 18 and the body 24, to isolate low-amplitude and high-frequency vibrations, or forces. In this regard, it may be desirable that a portion of the isolating member is less stiff than the jounce spring 2044, so that the isolating member 2200, not the jounce spring 2044, may absorb most of the vibrational forces.

The isolating member 2200 may generally include an upper isolator 2118 and a lower isolator 2120 disposed on either side of the vehicle component and coupled to the connecting ends 66, 76 and upper and lower retainers 2100, 2102. In this manner, the upper and lower isolators 2118, 2120 may absorb axial vibrational forces. Either of the upper isolator 2118 and the lower isolator 2120 may include a protrusion 2210 configured to be received within an aperture 2212 formed in the body 24. The protrusion 2210 may further absorb transverse vibrational forces. The isolators 2118, 2120 may be sandwiched between the upper and lower retainers 2100, 2102 and may be compressively engaged between a nut 2110 and a shoulder 2214, which may be formed on the respective connecting end 66, 76.

What is claimed is:

1. A suspension device comprising:
a casing defining a cavity, said cavity defining a stop face;
a piston slidably disposed in said cavity and offset from said stop face, said piston operable to move a predetermined axial distance toward said stop face when a force is imparted on one of said casing and said piston; and
a bumper member disposed in said cavity and between said stop face and said piston, said bumper member communicating with at least one of said piston and said end face and operable to elastically resist movement of said piston toward said end face when said piston reaches said predetermined distance.

2. The suspension device of claim 1, wherein said bumper member is characterized by a non-constant spring force and said non-constant spring force increases as said piston approaches said predetermined distance.

3. The suspension device of claim 2, wherein said non-constant spring force is linear.

4. The suspension device of claim 2, wherein said non-constant spring force is non-linear.

5. The suspension device of claim 2, wherein said bumper member is made from microcellular polyurethane.

6. The suspension device of claim 1, further comprising a spring disposed in said cavity and between said stop face and said piston, said spring operable to compress as said piston moves axially toward said stop face and absorb said force.

7. The suspension device of claim 6, wherein said spring and said bumper member are integrally formed.

8. The suspension device of claim 7, wherein said integrally formed spring and bumper member are made from microcellular polyurethane.

9. The suspension device of claim 8, wherein said suspension device further comprises a damper operable to resist axial movement of said piston within said cavity, regardless of an axial direction of movement of said piston.

10. A suspension device comprising:
a casing defining a cavity, said cavity defining a stop face;
a piston slidably disposed in said cavity and offset from said stop face, said piston operable to move a predetermined axial distance toward said stop face when a force is imparted on at least one of said casing and said piston; and
a spring disposed in said cavity and between said stop face and said piston, said spring communicating with said piston and said end face and characterized by a spring force/deflection curve, said spring operable to compress as said force is imparted on at least one of said casing and said piston,
wherein compressing said spring absorbs said force and permits said piston to move said predetermined axial distance and said spring force increases when said piston reaches said predetermined distance.

11. The suspension device of claim 10, wherein said spring force is linear.

12. The suspension device of claim 10, wherein said spring force is non-linear.

13. The suspension device of claim 10, wherein said spring is an elastomeric spring.

14. The suspension device of claim 13, wherein said spring is a microcellular polyurethane spring.

15. The suspension device of claim 13, wherein said spring defines a central axis and a cross-section of said spring, said cross-section taken generally perpendicular to said axis, varies in an axial direction.

16. A suspension device comprising:
a casing defining a cavity, said cavity defining a stop face;
a piston slidably disposed in said cavity and offset from said stop face, said piston operable to move axially relative to said stop face when a force is imparted on at least one of said casing and said piston;
a spring disposed in said cavity and between said stop face and said piston, said spring communicating with said piston and said end face and operable to compress as said piston moves toward said end face and to absorb said force; and
a friction damper disposed in said cavity and operable to generate frictional drag between said piston and said casing, wherein said frictional drag inhibits axial movement of said piston in said cavity.

17. The suspension device of claim 16, wherein said friction damper includes an elastomeric body coupled to one of said piston and said casing and communicating with said other one of said piston and said casing to generate said frictional drag.

18. The suspension device of claim 17, wherein said elastomeric body is compressed between said casing and said piston.

19. The suspension device of claim 16, further comprising an isolator disposed in said cavity, wherein said piston includes a shaft and a head portion and said isolator is coupled between said shaft and said head portion, and wherein said isolator permits relative movement between said shaft and said head portion when said force impinges on one of said casing and said shaft.

20. A damper comprising:
a casing defining a cavity, said cavity defining a stop face;
a piston slidably disposed in said cavity and defining an outer diameter, said piston operable to move axially relative to said stop face when a force impinges on at least one of said casing and said piston; and
an elastic body disposed in said cavity and compressed between said outer diameter of said piston and said casing, said compressed elastic body operable for damping axial movement of said piston in said cavity, wherein a magnitude of said damping changes as said piston moves axially in said cavity.

21. The damper of claim 20, wherein said magnitude of said damping is at least partially determined by a compressive force between said elastic body and one of said casing and said piston.

22. The damper of claim 21, wherein said compressive force changes as said piston moves axially within said cavity.

23. The damper of claim 20, wherein said magnitude of said damping is at least partially determined by a contact area between said elastic body and one of said casing and said piston.

24. The damper of claim 23, wherein said contact area changes as said piston moves axially within said cavity.

25. The damper of claim 20, wherein said elastic body is coupled to said piston and said elastic body and said casing define a contact area therebetween.

26. The damper of claim 25, wherein said contact area includes at least one groove formed therein.

27. The damper of claim 26, wherein said at least one groove extends generally circumferentially around said contact area.

28. The damper of claim 26, wherein said grooves extend generally longitudinally along said contact area.

29. The damper of claim 23, wherein said elastic body includes a plurality of protrusions and said protrusions communicate with said casing to define said contact area.

30. The damper of claim 29, wherein a first compressive force of said protrusions on said casing is different than a second compressive force of said protrusions on said casing, said first compressive force associated with movement of said piston in a first axial direction and said second compressive force associated with movement of said piston in a second axial direction opposite to said first axial direction.

31. The damper of claim 20, wherein a cross-section of said elastic body varies in an axial direction and said casing includes a transition portion protruding into said cavity and compressing said elastic body such that a compressive force changes as said piston moves axially relative to said transition portion.

32. A suspension control device incorporating at least one of a spring, a jounce bumper, a rebound bumper, and a damper, said suspension control device comprising:
a casing defining a cavity, said cavity defining a stop face;
a piston assembly having a piston body portion coupled to a connecting rod, said piston body portion slidably disposed in said cavity and operable to move axially relative to said stop face when a force impinges on one of said casing and said connecting rod; and
an isolator disposed in said cavity and coupled between said connecting rod and said piston body portion,
wherein said isolator permits relative axial movement between said connecting rod and said piston body portion when said force impinges on one of said casing and said connecting rod.

33. The suspension control device of claim 32, wherein said isolator is an elastic body.

34. The suspension control device of claim 33, wherein said isolator includes a first elastic body and a second elastic body, said first elastic body disposed on a top of said piston body portion and said second elastic body disposed on a bottom of said piston body portion.

35. The suspension control device of claim 33 wherein said isolator is integrally formed with said head portion.

36. A suspension device comprising:
a casing defining a cavity, said cavity defining a first stop face and a second stop face;
a piston slidably disposed in said cavity and between said first stop face and said second stop face, said piston moveable relative to said casing toward said first stop face when a force impinges on at least one of said casing and said piston;
a spring disposed in said cavity and between said first stop face and said piston, said spring communicating with said piston and said end face and compressible as said force impinging on at least one of said casing and said piston moves said piston relative to said casing, said compressed spring operable to urge said piston and said first stop face axially apart when said force is removed;
a rebound bumper disposed in said cavity and between said second stop face and said piston;
a friction damper disposed in said cavity and operable to generate frictional drag between said piston and said casing as said piston moves within said cavity.
